(19) United States
(12) Patent Application Publication
(10) Pub. No.: US 2002/0085146 A1
(43) Pub. Date: Jul. 4, 2002

(54) Liquid crystal display manufacturing method and liquid crystal display

(76) Inventor: Takashi Miyazaki, Nagano-ken (JP)

Correspondence Address: HARNESS, DICKEY & PIERCE, P.L.C., P.O. BOX 828, BLOOMFIELD HILLS, MI, 48303, US

(21) Appl. No.: 09/993,921

(22) Filed: Nov. 14, 2001

(30) Foreign Application Priority Data
Nov. 16, 2000 (JP) 2000-349638
Sep. 13, 2001 (JP) 2001-278774

(51) Int. Cl. G02F 1/1335

(52) U.S. Cl. 349/96

(57) ABSTRACT

A reflective polarizer 450 having a shape matching a liquid crystal panel 40 is disposed on the liquid crystal display behind the liquid crystal panel having, for example, a rectangular projected form, and the transmission axis direction 450a of the reflective polarizer 450 is set to be substantially parallel to an outer edge 450b thereof, and an outer edge 40b of the liquid crystal panel 40. The blank layout efficiency of reflective polarizers can be increased though the distinct vision direction B is slightly deviated from the direction of the visual angle at a six o'clock hour, and the manufacturing cost can be reduced, accordingly.

### BACKGROUND OF THE INVENTION

1. Technical Field of the Invention

The present invention relates to a liquid crystal display manufacturing method and a liquid crystal display, and more specifically, it relates to a manufacturing method of a liquid crystal display having a reflective polarizer or a polarization separator, and a structure of the liquid crystal display.

2. Description of the Related Art

Hitherto, among liquid crystal displays, a transflective liquid crystal display has been devised, which can realize both the reflective display in which the sunlight or the artificial indoor light is introduced from a display surface of a liquid crystal panel and the display is visually recognized by the reflection of the light, and the transmissive display in which the illumination light from a cold cathode ray tube, a light-emitting diode or the like is emitted from a back side of the liquid crystal panel in order to visually recognize the display in a dark place or in order to supplement the shortage of the quantity of the artificial light.

With the development of highly value-added portable electronic appliances represented by a PDA (Personal Digital Assistants) in recent years, came a liquid crystal display which can realize the high brightness in the display by using a reflective polarizer which reflects the polarized component in a predetermined direction. A transflective liquid crystal display having a reflective polarizer between a liquid crystal panel and an illumination appliance has been disclosed in the Japanese Unexamined Utility Model Publication No. 57-49271. Further, a reflective polarizer which can be used in the transflective liquid crystal display has been disclosed in Japanese Unexamined Patent Application Publication No. 9-506985 (by PCT Application).

The liquid crystal display generally has a dependency on an angle of view and an angle of azimuth of the contrast, and when the contrast is maximized in the direction inclined by a predetermined angle to a predetermined azimuth with respect to the normal direction of a display surface, the predetermined azimuth is referred to as the direction of distinct vision. This means that the direction of distinct vision is defined as the direction of a director which is a unit vector expressing the average direction of alignment of the major axis of liquid crystal molecules. In these liquid crystal displays having the predetermined direction of distinct vision, the direction of distinct vision is often set to the direction of 06:00 hours (the azimuth on the display surface expressed by the direction of a pointer of a watch, i.e., the direction toward the feet of an observer with respect to the reference posture of the liquid crystal display recognized by the observer, that is, the direction toward the bottom in the figure) in order for the user to see the display most easily.

An example of the configuration of a conventional liquid crystal display will be described more in detail. For example, as shown in FIG. 4(a), in a liquid crystal panel 30 constituted in an STN mode in which the rubbing direction 340a for an alignment layer on a front side substrate of a liquid crystal panel 30 is set to be the direction rotated by 30° counterclockwise when viewed from the front side (the observation side) with respect to the longitudinal direction of the liquid crystal panel 30 having a rectangular projected form (that is, the direction parallel to a long side of the projected form of the liquid crystal panel) (hereinafter, referred to as the “reference direction”), and the rubbing direction on an alignment layer on a back side substrate is set to the direction rotated by 30° clockwise with respect to the reference direction of the liquid crystal panel 30, the direction of distinct vision B can be set to the direction A of 06:00 hours if the absorption axis direction of a polarizer 310 disposed on the front side of the liquid crystal panel 30 is set to the direction rotated by 20° counterclockwise with respect to the reference direction, the retardation axis direction of a retardation film 330 is set to the direction rotated by 55° counterclockwise with respect to the reference direction, and the transmission axis direction 350a of a reflective polarizer 350 disposed on the back side of the liquid crystal panel 30 is set to 105° clockwise with respect to the reference direction.

In the design of the conventional liquid crystal display, the rubbing direction of a panel substrate (a direction in which the alignment layer applied on the substrate is rubbed by a rubbing cloth, etc., and this direction determines the initial alignment direction of the liquid crystal) and the twist angle of the liquid crystal layer are determined while considering other electro-optic characteristics such as the threshold and the speed of response so that the direction of distinct vision is set to be the direction of, for example, 06:00 hours, and the posture of the reflective polarizer (the azimuth of the transmissive polarization axis and the reflective polarization axis) is determined so as to be adapted to the above-determined rubbing direction and the twist angle.

The reflective polarizer 350 is cut out of a large sheet 8 having a rectangular projected form as shown in FIG. 6(a). This large sheet 80 comprises two different resin layers which are alternately laminated as described below, and manufactured by achieving the stretching after the extrusion as disclosed in Japanese Unexamined Patent Application Publication No. 9-506985 (by PCT Application) and it is generally constituted so that the transmission axis 80a thereof is parallel to the long side of the large sheet 80, and the reflection axis thereof not shown in the figure is parallel to the short side of the large sheet 80.

As described above, the posture of the reflective polarizer is determined according to the direction of distinct vision, the rubbing direction, the twist angle, and other electro-optic characteristics, and cannot be set freely, and thus, the transmissive polarization axis and the reflective polarization axis of the reflective polarizer are inclined to the edges of the reflective polarizer as shown in an example in FIG. 4(a). On the other hand, as shown in FIG. 6(a), in the large sheet 80 of the reflective polarizer, the transmission axis 80a thereof is parallel to the long side, and when the reflective polarizer 350 is cut out of the large sheet 80, the reflective polarizer must be cut so that sides 350b, 350c of the reflective polarizer 350 are diagonal to the longitudinal direction of the large sheet 80, and more wasteful portions which cannot be used as the reflective polarizer 350 are generated. In addition, the reflective polarizer 350 is generally very expensive, and the use of the expensive material considerably affects the manufacturing cost of the liquid crystal display, and thus, a problem occurs in that the wasteful portions of the material generated in cutting the reflective polarizer considerably increase the manufacturing cost of the liquid crystal display.

On the other hand, the large sheet for the reflective polarizer can be manufactured to the configuration of the liquid crystal panel in advance, that is, the reflective polarizer can be manufactured so that the transmission axis direction and the reflection axis direction of the large sheet are inclined to the edges thereof in advance. However, in such a configuration, the manufacturing cost is increased since the yield is degraded, and the manufacturing line becomes complicated in manufacturing steps of the large sheet including the stretching after the extrusion, and as a result, the reflective polarizer can be more expensive.

The present invention is made in light of the above problems, and an object is to provide a liquid crystal display which can reduce the manufacturing cost thereof by employing a structure of efficiently obtaining the reflective polarizer out of a large sheet.

### SUMMARY OF THE INVENTION

In order solve the above problems, a liquid crystal display manufacturing method in accordance with the present invention comprises a step of manufacturing a liquid crystal display comprising a liquid crystal panel with a liquid crystal layer disposed between two substrates, and a reflective polarizer which is disposed along the liquid crystal panel and has a projected form corresponding to a projected form of the liquid crystal panel, and is characterized in that a polarized component having the oscillating plane in the transmission axis direction is transmitted through the reflective polarizer and a polarized component having the oscillating plane in the reflection axis direction is reflected by the reflective polarizer, and that the liquid crystal panel is constituted with the direction of distinct vision of the liquid crystal panel deviated from a direction substantially parallel to or substantially perpendicular to one side of the projected form of the liquid crystal panel by a predetermined angle or an angle of the predetermined angle subtracted from 90° so that the transmission axis direction or the reflection axis direction is substantially parallel to or substantially orthogonal to one side of the projected form of the reflective polarizer.

In the present invention, the direction of distinct vision of the liquid crystal panel is deviated by the predetermined angle with respect to the original direction, and as a result, the transmission axis direction or the reflection axis direction of the reflective polarizer can be substantially parallel to or substantially orthogonal to one side of the projected form, the reflective polarizer can be formed without generating any wasteful fragments in cutting the reflective polarizer out of the large sheet, the use of the expensive material for the reflective polarizer can be reduced, and thus, the manufacturing cost of the liquid crystal display can be reduced. In addition, the manufacturing step need not be changed at all, and various kinds of liquid crystal panels can be easily manufactured.

The liquid crystal panel is preferably formed so that the angle formed between one side of the projected form of the liquid crystal panel or the direction orthogonal thereto and the direction of distinct vision is not greater than 30°.

Another liquid crystal display manufacturing method in accordance with the present invention comprises a step of manufacturing a liquid crystal display comprising a liquid crystal panel with a liquid crystal layer disposed between two substrates, and a reflective polarizer which is disposed along the liquid crystal panel and has a projected form corresponding to a projected form of the liquid crystal panel, and is characterized in that the polarized component having the oscillating plane in the transmission axis direction is transmitted through the reflective polarizer and the polarized component having the oscillating plane in the reflection axis direction is reflected by the reflective polarizer, and that the liquid crystal panel is constituted with the direction of distinct vision of the liquid crystal panel deviated from a direction substantially parallel to or substantially perpendicular to the longitudinal direction of the projected form of the liquid crystal panel by a predetermined angle or an angle of the predetermined angle subtracted from 90° so that the transmission axis direction or the reflection axis direction is substantially parallel to or substantially orthogonal to the longitudinal direction of the projected form of the reflective polarizer.

In the present invention, when the projected form of the reflective polarizer is an oriented shape, for example, an ellipse, a long circle, and other shapes oriented in other predetermined direction, the reflective polarizer can be efficiently cut out in a similar manner to the above, and the manufacturing cost can be reduced by setting the transmission axis direction or the reflection axis direction to be substantially parallel to or substantially orthogonal to the longitudinal direction thereof.

Methods of deviating the direction of distinct vision of the liquid crystal panel (the direction of the average director of the liquid crystal molecules) include various kinds of methods of changing the alignment state of the liquid crystal layer such as a method of changing the rubbing direction. In addition, if the other optical components such as the polarizer and the retardation film are provided, the characteristic directions thereof (such as the absorption axis and the retardation axis) must be changed so as to be substantially adapted to the deviation in the direction of distinct vision.

In the above-described inventions, the liquid crystal panel is preferably constituted so that the angle formed between one side of the projected form of the liquid crystal panel, the longitudinal direction of the projected form thereof, or the direction orthogonal thereto (for example, the direction of the angle of view at 06:00 hours) and the direction of distinct vision is not greater than 30°. Degradation of the substantial display characteristic of the liquid crystal display can be suppressed by setting the angle of inclination of the direction of distinct vision to be not greater than 30°.

Still another liquid crystal display manufacturing method in accordance with the present invention comprises a step of manufacturing a liquid crystal display comprising a liquid crystal panel with a liquid crystal layer disposed between two substrates, and a reflective polarizer which is disposed along the liquid crystal panel and has a projected form corresponding to a projected form of the liquid crystal panel, and is characterized in that the polarized component having the oscillating plane in the transmission axis direction is transmitted through the reflective polarizer and the polarized component having the oscillating plane in the reflection axis direction is reflected by the reflective polarizer, and that the alignment treatment of determining the initial alignment direction of the liquid crystal molecules in the liquid crystal layer is achieved by deviating the initial alignment direction by a predetermined angle or an angle of the predetermined angle subtracted from 90° so that the transmission axis direction or the reflection axis direction is substantially parallel to or substantially orthogonal to one side or the longitudinal direction of the projected form of the reflective polarizer.

In the present invention, in achieving the alignment treatment of determining the initial alignment treatment of the liquid crystal molecules in the liquid crystal layer of the liquid crystal panel (for example, the rubbing treatment of the alignment layer), the initial alignment direction is deviated by the predetermined angle or the angle of the predetermined angle subtracted from 90° with respect to the original direction in which the direction of distinct vision of the liquid crystal panel is parallel to or perpendicular to one side or the longitudinal direction of the liquid crystal panel, and thus, the transmission axis direction or the reflection axis direction of the reflective polarizer can be constituted so as to be substantially parallel to or substantially orthogonal to one side or the longitudinal direction of the projected form, and the fragments can be reduced when cutting the reflective polarizer out of the large sheet, and the manufacturing cost can be reduced.

In the present invention, the liquid crystal panel is preferably constituted so that the predetermined angle is not greater than 30°. In accordance with the present invention, the direction of distinct vision is also deviated by the angle corresponding to the predetermined angle by deviating the initial alignment direction by the predetermined angle. However, the angular deviation of the direction of distinct vision from the reference direction can also be reduced, and thus, degradation of the visibility of the liquid crystal display can be suppressed.

In the present invention, the reflective polarizer in which the transmission axis direction is substantially orthogonal to the reflection axis direction is preferably used. By using the reflective polarizer with the transmission axis direction thereof orthogonal to the reflection axis direction thereof, the linear polarized component transmitted through the reflective polarizer can be efficiently separated from the linear polarized component reflected by the reflective polarizer, and as a result, the optical loss can be reduced when using at least one of the transmitted light and the reflecting light, and a bright display can be realized.

Still another liquid crystal display manufacturing method in accordance with the present invention comprises a step of manufacturing a liquid crystal display comprising a liquid crystal panel, and a polarizer and a polarization separator which are disposed on both sides of the liquid crystal panel there across, and is characterized in that the polarization separator has a projected form corresponding to a projected form of the liquid crystal panel and allows the light to be transmitted there through or reflected thereby according to the linear polarized component thereof, and that the liquid crystal panel is constituted with the direction of distinct vision of the liquid crystal panel deviated from a direction substantially parallel to or substantially perpendicular to one side of the projected form of the liquid crystal panel by a predetermined angle or an angle of the predetermined angle subtracted from 90° so that the polarization direction of the linear polarized component transmitted through or reflected by the polarization separator is substantially parallel to or substantially orthogonal to one side of the projected form of the polarization separator.

In the present invention, the direction of distinct vision of the liquid crystal panel is deviated from the original direction by the predetermined angle, and as a result, the polarization direction of the linear polarized component which is transmitted or reflected by the polarization separator is substantially parallel to or substantially orthogonal to one side of the projected form, and fragments when cutting the reflective polarizer out of the large sheet can be reduced, and the manufacturing cost can be reduced.

In the present invention, the liquid crystal panel is preferably constituted so that the predetermined angle is not greater than 30°. In accordance with the present invention, the direction of distinct vision is also deviated by the angle corresponding to the predetermined angle by deviating the initial alignment direction by the predetermined value. However, the angular deviation of the direction of distinct vision from the reference direction can also reduced by setting the predetermined angle to be not greater than 30°, and degradation of the visibility of the liquid crystal display can be suppressed.

In the present invention, the liquid crystal panel is preferably constituted so that the angle formed between one side of the projected form of the liquid crystal panel or the direction orthogonal thereto and the direction of distinct vision is not greater than 30°.

In addition, still another liquid crystal display manufacturing method in accordance with the present invention comprises a step of manufacturing a liquid crystal display comprising a liquid crystal panel, and a polarizer and a polarization separator which are disposed on both sides of the liquid crystal panel there across, and is characterized in that the polarization separator has a projected form corresponding to a projected form of the liquid crystal panel and allows the light to be transmitted there through or reflected thereby according to the linear polarized component thereof, and that the liquid crystal panel is constituted with the direction of distinct vision of the liquid crystal panel deviated from a direction substantially parallel to or substantially perpendicular to one side of the projected form of the liquid crystal panel by a predetermined angle or an angle of the predetermined angle subtracted from 90° so that the polarization direction of the linear polarized component transmitted through or reflected by the polarization separator is substantially parallel to or substantially orthogonal to the longitudinal direction of the projected form of the polarization separator.

In the present invention, the direction of distinct vision of the liquid crystal panel is deviated from the original direction by the predetermined angle, and as a result, the polarization direction of the linear polarized component which is transmitted or reflected by the polarization separator is substantially parallel to or substantially orthogonal to the longitudinal direction of the projected form, and fragments when cutting the reflective polarizer out of the large sheet can be reduced, and the manufacturing cost can be reduced.

In the present invention, the liquid crystal panel is preferably constituted so that the angle formed between the longitudinal direction of the projected form of the liquid crystal panel or the direction orthogonal thereto and the direction of distinct vision is not greater than 30°.

In addition, a still further liquid crystal display manufacturing method in accordance with the present invention comprises a step of manufacturing a liquid crystal display comprising a liquid crystal panel, and a polarizer and a polarization separator which are disposed on both sides of the liquid crystal panel there across, and is characterized in that the polarization separator has a projected form corresponding to a projected form of the liquid crystal panel and allows the light to be transmitted there through or reflected thereby according to the linear polarized component thereof, and that the alignment treatment of determining the initial alignment direction of the liquid crystal molecules in the liquid crystal layer is achieved by deviating the initial alignment direction by a predetermined angle or an angle of the predetermined angle subtracted from 90° so that the polarization direction of the linear polarized component transmitted through or reflected by the polarization separator is substantially parallel to or substantially orthogonal to one side or the longitudinal direction of the projected form of the polarization separator.

In the present invention, in achieving the alignment treatment of determining the initial alignment treatment of the liquid crystal molecules in the liquid crystal layer of the liquid crystal panel (for example, the rubbing treatment of the alignment layer), the initial alignment direction is deviated by the predetermined angle or the angle of the predetermined angle subtracted from 90° with respect to the original direction in which the direction of distinct vision of the liquid crystal panel is parallel to or perpendicular to one side or the longitudinal direction of the liquid crystal panel, and thus, the polarization direction of the linear polarized component transmitted or reflected by the polarization separator can be substantially parallel to or substantially orthogonal to the longitudinal direction of the projected form of the polarization separator, and the fragments can be reduced when cutting the reflective polarizer out of the large sheet, and the manufacturing cost can be reduced.

In the present invention, the liquid crystal panel is preferably constituted so that the predetermined angle is not greater than 30°.

In the present invention, the polarization separator in which the transmission axis direction indicating the polarization axis direction with the maximum transmissivity of the linear polarized component is substantially orthogonal to the reflection axis direction with the maximum reflectance of the linear polarized component is preferably used.

In each of the above inventions, the design example of the liquid crystal display having the predetermined direction of distinct vision and the predetermined posture of the reflective polarizer (or the polarization separator) in advance is set to be a reference, and the liquid crystal display can be constituted without any re-design by rotating with respect to the design example every optical element in which the initial alignment direction of the liquid crystal or other optical characteristics are dependent on the azimuth by the angle of change required for changing the posture of the reflective polarizer so that transmission axis direction or the reflection axis direction of the reflective polarizer (the polarization direction in which the transmissivity or the reflectance of the linear polarized component is maximum by the polarization separator) is substantially parallel to or substantially orthogonal to one side or the longitudinal direction of the projected form of the reflective polarizer (polarization separator).

Next, a liquid crystal display in accordance with the present invention comprises a liquid crystal panel having a pair of substrates and a reflective polarizer disposed along one of the substrates, and is characterized in that the reflective polarizer allows the polarized component having the oscillating plane in the transmission axis direction to be transmitted there through and the polarized component having the oscillating plane in the reflection axis direction to be reflected thereby, and the reflective polarizer is constituted so that the transmission axis direction or the reflection axis direction is substantially parallel to or substantially orthogonal to one side of the projected form thereof.

In the present invention, the transmission axis direction or the reflection axis direction of the reflective polarizer is substantially parallel to or substantially orthogonal to one side of the projected form, and when the reflective polarizer is cut out of a large sheet constituted so that the transmission axis direction or the reflection axis direction is substantially parallel to or substantially orthogonal to one side of the projected form, the reflective polarizer can be cut out of the large sheet so that one side of the reflective polarizer is substantially parallel to the side direction of the large sheet, and as a result, the blank layout efficiency of the reflective polarizer is increased, and wasteful portions can be reduced.

In another liquid crystal display in accordance with the present invention comprises a liquid crystal panel having a pair of substrates and a reflective polarizer disposed along one of the substrates, and is characterized in that the reflective polarizer allows the polarized component having the oscillating plane in the transmission axis direction to be transmitted there through and the polarized component having the oscillating plane in the reflection axis direction to be reflected thereby, and the reflective polarizer is constituted so that the transmission axis direction or the reflection axis direction is substantially parallel to or substantially orthogonal to the longitudinal direction of the projected form thereof.

In the present invention, when the projected form of the reflective polarizer has an oriented shape, for example, an ellipse, a long circle, and other shapes oriented in other predetermined direction, the cutting-out efficiency of the reflective polarizer can be increased in a similar manner to the above, and the wasteful portion can be reduced by setting the transmission axis direction or the reflection axis direction to be substantially parallel to or substantially orthogonal to the longitudinal direction thereof.

Still another liquid crystal display in accordance with the present invention comprises a liquid crystal panel having a liquid crystal layer between two substrates and a reflective polarizer disposed on the side opposite to a display surface of the liquid crystal panel, and is characterized in that the reflective polarizer allows the polarized component having the oscillating plane in the transmission axis direction to be transmitted there through and the polarized component having the oscillating plane in the reflection axis direction to be reflected thereby, and the reflective polarizer is constituted so that the transmission axis direction or the reflection axis direction is substantially parallel to or substantially orthogonal to one side of the projected form thereof.

In the present invention, the cutting-out efficiency of the reflective polarizer can be increased in a similar manner to the above, and the wasteful portion can be reduced by setting the transmission axis direction or the reflection axis direction to be substantially parallel to or substantially orthogonal to one side of the reflective polarizer.

Still another liquid crystal display in accordance with the present invention comprises a liquid crystal panel having a liquid crystal layer between two substrates and a reflective polarizer disposed on the side opposite to a display surface of the liquid crystal panel, and is characterized in that the reflective polarizer allows the polarized component having the oscillating plane in the transmission axis direction to be transmitted there through and the polarized component having the oscillating plane in the reflection axis direction to be reflected thereby, and the reflective polarizer is constituted so that the transmission axis direction or the reflection axis direction is substantially parallel to or substantially orthogonal to the longitudinal direction of the projected form thereof.

Still another liquid crystal display in accordance with the present invention comprises a liquid crystal panel having a liquid crystal layer between two substrates and a liquid crystal display area of a predetermined projected form and a reflective polarizer disposed behind the liquid crystal panel and having the projected form substantially similar to the liquid crystal display area, and is characterized in that the reflective polarizer allows the polarized component having the oscillating plane in the transmission axis direction to be transmitted there through and the polarized component having the oscillating plane in the reflection axis direction to be reflected thereby, and the reflective polarizer is disposed in a posture so that the transmission axis direction or the reflection axis direction is substantially parallel to one side of the projected form of the liquid crystal display area.

Still another liquid crystal display in accordance with the present invention comprises a liquid crystal panel having a liquid crystal layer between two substrates and a liquid crystal display area of a predetermined projected form and a reflective polarizer disposed behind the liquid crystal panel and having the projected form substantially similar to the liquid crystal display area, and is characterized in that the reflective polarizer allows the polarized component having the oscillating plane in the transmission axis direction to be transmitted there through and the polarized component having the oscillating plane in the reflection axis direction to be reflected thereby, and the reflective polarizer is disposed so that the transmission axis direction or the reflection axis direction is substantially parallel to the longitudinal direction of the projected form of the liquid crystal display area.

In the above inventions, the projected form of the liquid crystal panel or the reflective polarizer preferably has a shape with at least one straight outer edge, or an oriented shape on the whole. The former case includes, in particular, a substantially polygonal shape, that is, a round-cornered polygon and a corner-cut polygon in addition to the polygons such as a rectangle and a square. The latter case includes an ellipse, a long circle and a rectangle.

In the present invention, a first polarizer is disposed on a front side of the liquid crystal panel, the polarized light transmitted through the first polarizer is preferably controlled according to the voltage applied to the liquid crystal layer whether or not the polarized light is reflected by the reflective polarizer after being transmitted through the liquid crystal panel, and emitted from the first polarizer after transmitted through the liquid crystal panel. In this configuration, whether or not the reflecting light obtained by reflecting the light reaching behind the liquid crystal panel out of the polarized light transmitted through the first polarizer by the reflective polarizer is emitted can be controlled according to the drive state of the liquid crystal panel, and thus, a reflective display means can be constituted thereby. In this configuration, a reflective liquid crystal display can also be constituted, and further, a transflective liquid crystal display can also be constituted as described below. In addition, a liquid crystal display which controls the hue by the function of the reflective polarizer by disposing a filter or a reflector having a predetermined hue before and behind the reflective polarizer.

In the present invention, a light source can be disposed behind the reflective polarizer. In such a configuration, the transflective display liquid crystal display can be realized by the light transmitted through the reflective polarizer out of the illumination light emitted from the light source.

In the present invention, the liquid crystal display is a transflective display liquid crystal display having the reflective display function which implements the display by the reflection of the external light and the transmissive display function which implements the display by the transmission of the light emitted from the light source.

In the present invention, the liquid crystal panel may have a liquid crystal layer in an STN mode. STN is referred to as the Super-Twisted Nematic. The extensive range of the visual angle with the sufficient visibility compared with that of other modes can be ensured, and thus, the effect on the visibility can be reduced even when the direction of distinct vision is slightly deviated from the normal direction.

In the present invention, a second polarizer which absorbs the light transmitted through the reflective polarizer is preferably disposed behind the reflective polarizer. In accordance with the present invention, the second polarizer disposed behind the reflective polarizer absorbs the transmitted light through the reflective polarizer, and as a result, degradation of the display quality caused by the mixing of the transmitted light in the display, such as the reduction of the contrast by returning the transmitted light to the front side again in the reflective display of the liquid crystal display can be suppressed.

In the present invention, the second polarizer is preferably disposed behind the reflective polarizer, so that the transmission axis of the reflective polarizer is diagonal to the absorption axis of the second polarizer, that is, both axes are neither parallel to each other nor orthogonal to each other. Since the transmission axis of the reflective polarizer is neither parallel to nor orthogonal to the absorption axis of the second polarizer disposed behind the reflective polarizer, the light from the light source can be introduced in the liquid crystal panel via the second polarizer and the reflective polarizer, and as a result, the transmissive display can be realized when the light source is disposed behind the second polarizer, and at the same time, a part of the light transmitted through the reflective polarizer out of the external light introduced from the display surface is absorbed by the second polarizer, and the mixing quantity of the scattering light and the reflecting light attributable to the light transmitted through the reflective polarizer can be reduced, and thus, the high contrast and the bright display can be obtained.

Next, another liquid crystal display in accordance with the present invention comprises a liquid crystal panel, a polarizer and a polarization separator disposed on both sides of the liquid crystal panel there across, and is characterized in that the polarization separator has a projected form corresponding to a projected form of the liquid crystal panel, and allows the light to be transmitted there through and reflected thereby according to the linear polarized component, and the polarization direction of the linear polarized component transmitted through or reflected by the polarization separator is substantially parallel to or substantially orthogonal to one side of the projected form of the polarization separator.

In the present invention, the polarization direction of the linear polarized component transmitted through or reflected by the polarization separator is substantially parallel to or substantially orthogonal to one side of the projected form of the polarization separator, and thus, fragments can be reduced when cutting the polarization separator out of a large sheet, and the manufacturing cost can be reduced.

In the present invention, the angle formed between one side of the projected form of the liquid crystal panel or the direction orthogonal thereto and the direction of distinct vision of the liquid crystal panel is preferably not greater than 30°.

Still another liquid crystal display in accordance with the present invention comprises a liquid crystal panel, a polarizer and a polarization separator disposed on both sides of the liquid crystal panel there across, and is characterized in that the polarization separator has a projected form corresponding to a projected form of the liquid crystal panel, and allows the light to be transmitted there through and reflected thereby according to the linear polarized component, and the polarization direction of the linear polarized component transmitted through or reflected by the polarization separator is substantially parallel to or substantially orthogonal to the longitudinal direction of the projected form of the polarization separator.

In the present invention, the polarization direction of the linear polarized component transmitted through or reflected by the polarization separator is substantially parallel to or substantially orthogonal to the longitudinal direction of the projected form of the polarization separator, and thus, fragments can be reduced when cutting the polarization separator out of a large sheet, and the manufacturing cost can be reduced.

In the present invention, the angle formed between the longitudinal direction of the projected form of the liquid crystal panel or the direction orthogonal thereto and the direction of distinct vision of the liquid crystal panel is preferably not greater than 30°.

In the present invention, the polarization separator is preferably constituted so that the transmission axis direction indicating the polarization axis direction with the maximum transmissivity of the linear polarized component is substantially orthogonal to the reflection axis direction indicating the polarization axis direction with the maximum reflectance of the linear polarized component.

In the present invention, the second polarizer which absorbs the light transmitted through the polarization separator is preferably disposed behind the polarization separator.

In the present invention, a second polarizer is disposed behind the polarization separator and the polarization separator is preferably constituted so that the transmission axis direction indicating the polarization axis direction with the maximum transmissivity of the linear polarized component of the polarization separator is diagonal to the reflection axis direction with the maximum absorption of the linear polarized component of the second polarizer.

In the present invention, the liquid crystal panel preferably has a liquid crystal layer in the STN mode.

In the above inventions, the reflective polarizer (or the polarization separator) preferably allows the light in the substantially total wavelength range of the visible light area to be transmitted there through or reflected thereby according to the linear polarized component. The light utilization efficiency can be improved thereby, and the bright display can be visually recognized.

The reflective polarizer (or the polarization separator) includes a multi-layered film with a plurality of layers laminated thereon, and the refractive index of the plurality of layers is substantially equal to each other in the predetermined direction between adjacent layers, but different from each other in the direction orthogonal to the predetermined direction. The reflective polarizer may have a structure with a cholesteric layer and a quarter wavelength plate laminated thereon.

The liquid crystal panel includes a TN liquid crystal panel, an STN liquid crystal panel, an F-STN (Film-compensated STN) liquid crystal panel and an ECB liquid crystal panel.

### BRIEF DESCRIPTION OF THE DRAWINGS

FIG. 1 is a schematic perspective view of a principle structure of a reflective polarizer used in individual embodiments of a liquid crystal display in accordance with the present invention.

FIG. 2 is a schematic longitudinal sectional view of a structure of the liquid crystal display according to a first embodiment of the present invention.

FIG. 3 is a schematic longitudinal sectional view of a structure of the liquid crystal display according to a second embodiment of the present invention.

FIG. 4(a) is a schematic representation of the characteristic direction of individual components of a conventional liquid crystal display when viewed from the display surface side, and FIG. 4(b) is a schematic representation of the characteristic direction of individual components of the liquid crystal display according to the first embodiment when viewed from the display surface side.

FIG. 5(a) is a schematic representation of the characteristic direction of individual components of a conventional liquid crystal display when viewed from the display surface side, and FIG. 5(b) is a schematic representation of the characteristic direction of individual components of the liquid crystal display according to the second embodiment when viewed from the display surface side.

FIG. 6(a) is a schematic representation of a conventional reflective polarizer which is cut out of a large sheet, and FIG. 6(b) is a schematic representation of the reflective polarizer according to the present embodiment which is cut out of a large sheet.

FIGS. 7(a) and 7(b) are schematic representations of reflective polarizers having different projected forms which are cut out of a large sheet.

FIGS. 8(a) and 8(b) are schematic representations of reflective polarizers having another different projected forms which are cut out of a large sheet.

FIGS. 9(a) and 9(b) are schematic representations of reflective polarizers having still another different projected forms which are cut out of a large sheet.

FIGS. 10(a) and 10(b) are schematic representations of reflective polarizer having still further another different projected forms which are cut out of a large sheet.

### DETAILED DESCRIPTION OF THE PREFERRED EMBODIMENTS

The embodiments of the liquid crystal display in accordance with the present invention will be described in detail.

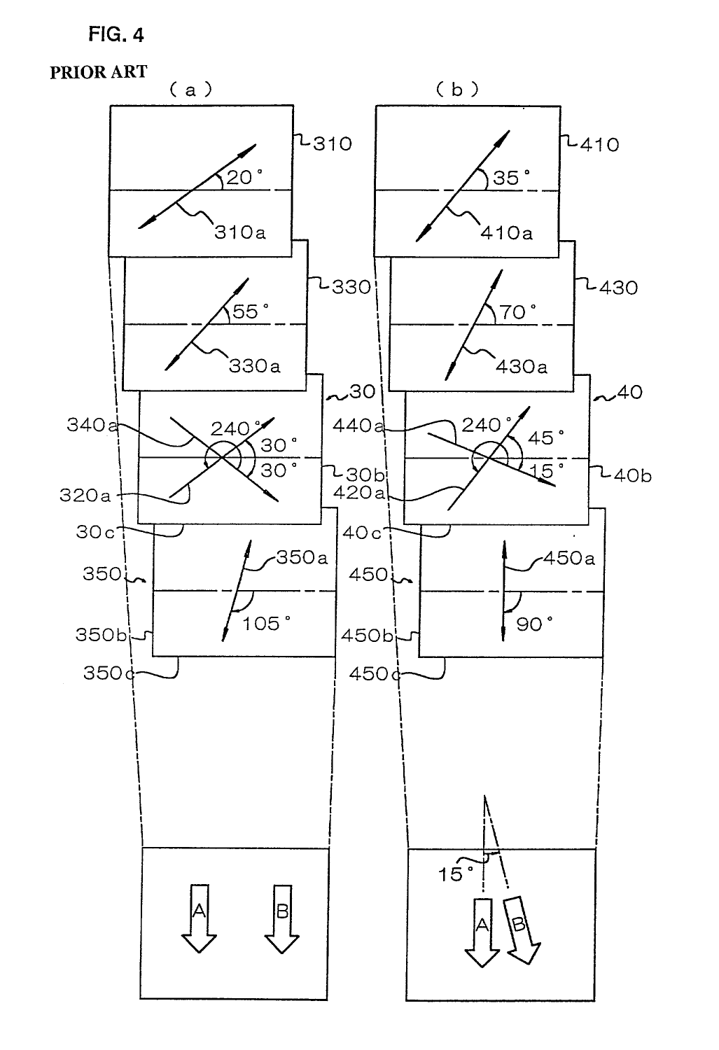

The first embodiment of the present invention will be described with reference to FIGS. 2 and 4(b). FIG. 2 is a schematic sectional view of the liquid crystal display according to the first embodiment of the present invention. FIG. 4(b) is a schematic plan view of a characteristic direction (a direction of determining the function of components) of individual components of the liquid crystal display according to the first embodiment of the present invention when viewed from the front side (the observation side).

A liquid crystal display 10 according to the present embodiment comprises a transmissive liquid crystal panel 40, a retardation film 430 and a polarizer 410 which are successively laminated on a display surface of the liquid crystal panel 40, a backlight 50 disposed behind the liquid crystal panel 40, and a reflective polarizer (polarization separator) 450 disposed between the liquid crystal panel 40 and the backlight 50.

The polarizer 410 is constituted to allow the polarized component having the oscillating plane in a predetermined direction to be transmitted there through, and absorb the polarized component having the oscillating plane in the direction orthogonal to the predetermined direction. The retardation film 430 is an optical compensating plate (a film) having a predetermined double refraction.

The liquid crystal panel 40 has a structure in which a liquid crystal layer 120 is held by a front side substrate 420 and a back side substrate 440 comprising a pair of flat rectangular glass substrates or the like. The front side substrate 420 and the back side substrate 440 are transparent, and capable of transmitting the light in the visible range. A transparent electrode 422 formed of ITO (Indium Tin Oxide: an alloy oxide film of indium and tin), etc. is laminated on inner surfaces of the substrates 420, 440 by the vapor deposition method or the sputtering method, and an insulation layer formed of SiO₂ (silicon dioxide), etc. not shown in the figure is laminated thereon by the sputtering method, etc., and an alignment layer formed of a polyimide resin, etc. obtained by the thermosetting treatment not shown in the figure is provided further thereon. A known rubbing treatment is implemented on the surface of the alignment layer provided on the front side substrate 420 by winding a flocked cloth or the like around a cylindrical roller, and rotating the roller.

The reflective polarizer 450 is stuck to a back side of the back side substrate 440. The reflective polarizer 450 has the reflection axis to reflect the polarized component having the oscillating plane along one direction and the transmission axis to transmit the polarized component having the oscillating plane along the other direction among the directions substantially orthogonal to each other. Generally, the reflective polarizer (the polarization separator) may be constituted to allow the linear polarized component in one direction to be transmitted, and to reflect the linear polarized component in the other direction. When the transmission axis direction is defined as the polarization direction of the linear polarized component having the highest transmissivity and the reflection axis direction is defined as the polarization direction of the linear polarized component having the highest reflectance, the transmission axis direction and the reflection axis direction need not be orthogonal to each other. However, when the transmission axis direction is orthogonal to the reflection axis direction, the utilization efficiency of the light is maximized, and the light can be transmission or reflected in the most efficient manner.

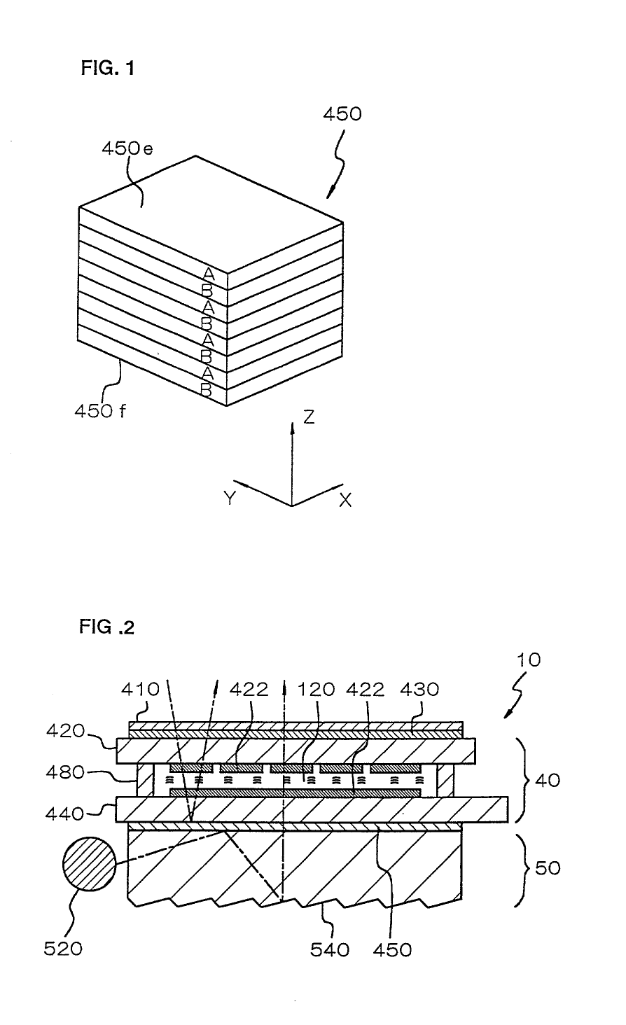

As shown in FIG. 1, the reflective polarizer 450 has a configuration in which two different layers (a Layer A and a Layer B) are alternately laminated in a plurality of sets, the Layer A is constituted so that the refractive index (nAX) in X-direction in the plane thereof is different from the refractive index (nAY) in Y-direction, while the Layer B is constituted so that the refractive index (nBX) in X-direction in the plane thereof is the same as the refractive index (nBY) in Y-direction, and the refractive index in Y-direction is equal to the refractive index (nAY) in Y-direction of Layer A.

As a result, the linear polarized component in Y-direction out of the light introduced in Z-direction from an upper surface 450e of the reflective polarizer 450 is transmitted through the reflective polarizer 450, and emitted from a lower surface 450f of the reflective polarizer 450 as the linear polarized light in Y-direction. On the other hand, the linear polarized component in Y-direction of the light introduced in Z-direction from the lower surface 450f is transmitted through the reflective polarizer 450, and emitted from the upper surface 450e as the linear polarized light. Thus, the direction of the oscillating plane of the polarized component transmitted through the reflective polarizer 450, i.e., Y-direction in this case, is referred to as the transmission axis direction.

On the other hand, the thickness of Layer A in Z-direction is expressed by tA, the thickness of Layer B in Z-direction is expressed by tB, and the wavelength of the introduced light is expressed by λrespectively.

tA·nAX 30 tB·nBX=λ/2 (1)

By satisfying the above formula, the linear polarized component in X-direction out of the light which has the wavelength of X and is introduced in Z-direction from the upper surface 450e of the reflective polarizer 450 is reflected. The linear polarized component in X-direction out of the light introduced in Z-direction from the lower surface 450f of the reflective polarizer 450 is similarly reflected. Thus, the direction of the oscillating plane of the polarized component reflected by the reflective polarizer 450, i.e., X-direction in this case, is referred to as the reflection axis direction.

By establishing the above formula (1) over the entire wavelength range of the visible light by extensively changing the thickness tA of The Layer A in Z-direction and the thickness tB of The Layer B in Z-direction, the reflective polarizer which can reflect the linear polarized component in X-direction thereby and allow the linear polarized component in Y-direction to be transmitted there through can be obtained for the total light in the visible area.

The above Layer A can include an oriented polyethylene naphtalate (PEN). The above Layer B can include a copolyester (coPEN; co-polyester of naphthalene dicarboxylic acid and terephthallic or isothalic acid).

In the present embodiment, the polarization separator of the above lamination structure is employed. In addition to such a polarization separator, for example, a unit with a cholesteric liquid crystal layer held by retardation films (quarter-wave plates), a unit using a Brewster's angle (SID 92 DIGEST, Page 427-429), a unit using the hologram, etc. have similar functions to that of the above polarization separator, and thus, these units may be used in place of the polarization separator of the above lamination structure.

The backlight 50 comprises a light guide plate 540 stuck to a back side of a reflective polarizer 450 and an LED (Light Emitting Diode) 520 which is disposed toward one end face of the light guide plate 540 and emits the light. The light guide plate 540 is disposed facing the substantially entire back side of the liquid crystal panel 40. The light guide plate 540 receives the light emitted from the LED 520 from one end surface thereof, and then, emits the light from the entire surface toward the back side of the liquid crystal panel 40 in a substantially uniform manner while being transmitted through the inside thereof in the plate surface direction.

As described above, the transmission axis direction of the reflective polarizer in the conventional liquid crystal display shown in FIG. 4(a) is inclined to each side of the projected form of the reflective polarizer by 105° (or 15°). On the other hand, in the liquid crystal display 10 according to the present embodiment as shown in FIG. 4(b), the transmission axis direction 450a of the reflective polarizer 450 is parallel to an outer edge 450b thereof, and orthogonal to an outer edge 450c thereof. The liquid crystal display area of the liquid crystal panel 40 is substantially similar to the projected form of the reflective polarizer 450, and outer edges 40b, 40c are installed parallel to the outer edges 450b, 450c of the reflective polarizer 450, respectively. This means that the transmission axis direction 450a and the extending direction of the outer edge 40b of the liquid crystal display area are parallel to each other, and the transmission axis direction 450a is orthogonal to the extending direction of the outer edge 40c of the liquid crystal display area.

In the present embodiment, in order to set the transmission axis direction 450a of the reflective polarizer 450 parallel to or orthogonal to the outer edges 40b, 40c as described above, the absorption axis direction 410a of the polarizer 410, the retardation axis direction 430a of the retardation film 430, and the rubbing directions 420a, 440a of the alignment layer in the liquid crystal panel 40 are rotated respectively by the differential angle between the transmission axis direction 350a of the reflective polarizer 350 in a liquid crystal display of a conventional structure shown in FIG. 4(a) and the transmission axis direction 450a of the reflective polarizer 450 according to the present embodiment.

In an example shown in the figure, the above differential angle is 15° counterclockwise when viewed from the front side, and all the directions 310a, 330a, 320a and 340a are rotated by 15° counterclockwise when viewed from the front side to set these directions to be the directions 410a, 430a, 420a and 440a. More specifically, the absorption axis direction 410a of the polarizer 410 is the direction rotated by 35° counterclockwise when viewed from the observation side with respect to the direction parallel to one side of the projected form thereof (in the example in the figure, the extending direction of the longer side is the longitudinal direction (the right-to-left direction in the figure), and this direction is simply referred to as the “reference direction”), the retardation axis direction 430a of the retardation film 430 is the direction rotated counterclockwise by 70° with respect to the reference direction, the rubbing direction 420a of the front side substrate of the liquid crystal panel 40 is the direction rotated counterclockwise by 45° with respect to the reference direction, and the rubbing direction 440a of the back side substrate is the direction rotated clockwise by 15° with respect to the reference direction.

The retardation value which is the product of the refractive index An of the liquid crystal layer 120 and the thickness d of the liquid crystal layer is in a range of 0.7 to 0.9 nm, the liquid crystal molecules are twisted by 220° to 260° to the left toward the vicinity of the front side substrate 420 from the vicinity of the back side substrate 440 in the initially aligned state, and used as the liquid crystal layer of the STN (Super-Twisted Nematic) double refraction mode. In the liquid crystal layer 120, the alignment direction of the liquid crystal molecules is changed according to the applied state of the electric field, and the polarized state of the transmitted light is changed. For example, if no voltage is applied and the liquid crystal molecules in the liquid crystal layer 120 are twisted by the above angle on the panel surface, the liquid crystal molecules are aligned in the application direction of the electric field by applying the voltage, and the double refraction of the liquid crystal layer 120 is changed by the change in the alignment direction of the liquid crystal molecules.

The retardation value of the retardation film 430 disposed on the display surface side (the observation side) of the liquid crystal panel 40 is 600 nm.

To realize the above configuration, optical elements other than the reflective polarizer 450 may be manufactured so that the characteristic direction is the direction rotated counterclockwise by a predetermined angle (15° in the example in the figure) when viewed from the front side under the condition shown in FIG. 4(a). More specifically, the polarizer 410 and the retardation film 430 are formed by cutting them in different postures so that the absorption axis 410a and the retardation axis 430a are in the direction rotated by the predetermined angle. In the liquid crystal panel 40, the alignment direction is rotated by the predetermined angle similar to the above when the predetermined alignment is given to inner surfaces (surfaces facing each other) of two substrates 420, 440 constituting the liquid crystal panel 40. For example, the rubbing treatment is implemented to the alignment layer formed on the substrate in the rubbing direction rotated by the predetermined angle.

As a result of the above configuration realized according to the present embodiment, the liquid crystal panel 40 according to the present embodiment has a structure in which the liquid crystal panel is rotated counterclockwise by 15° when viewed exactly from the front side with respect to the liquid crystal panel 30 of a conventional structure, and the distinct vision direction B is also the direction rotated counterclockwise by 15° with respect to the conventional liquid crystal panel, i.e., the visual angle direction of 05:30 hours. In the present embodiment, the distinct vision direction B is slightly deviated from the direction A of 06:00 hours orthogonal to the above reference direction, but the deviation of this degree affects little on the display quality. For example, assuming that the optimum direction with the most excellent display quality in practical applications is the case in which the visual angle direction of 06:00 hours is the distinct angle direction B, the distinct angle direction B is preferably within a range of ±30° with respect to the optimum direction. If the angle between the distinct angle direction B and the visual angle direction A of 06:00 hours is within 30°, more particularly, in the present embodiment having the liquid crystal layer in the STN mode, the visual angle characteristic is relatively smoother than that in other modes, and an excellent visibility can be ensured over an extensive angular range, and few practical problems occur.

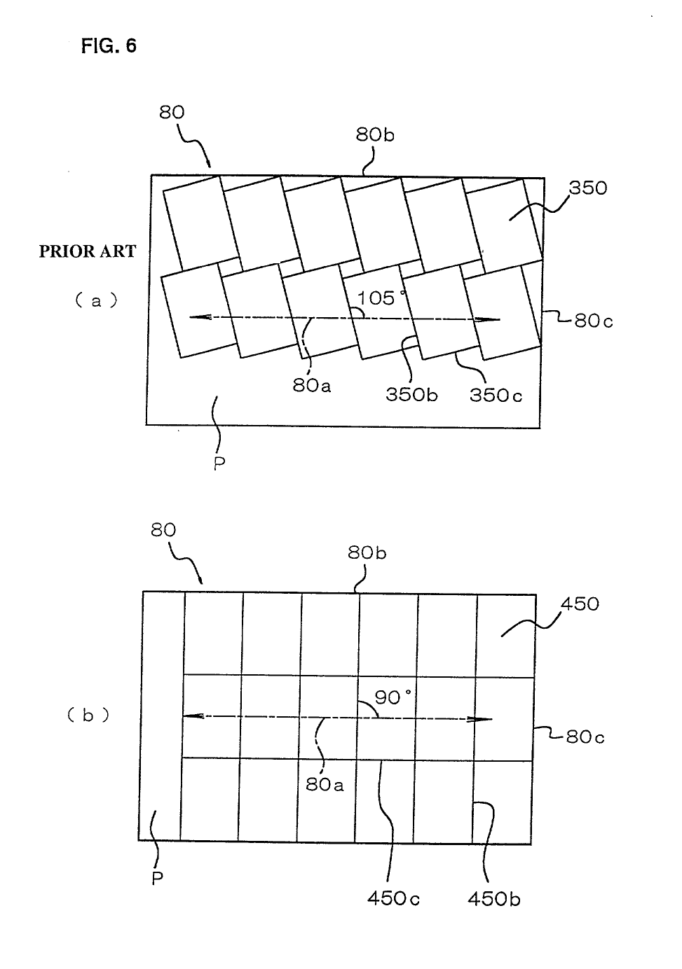

In this first embodiment, the transmission axis direction 450a of the reflective polarizer 450 is parallel to the outer edge 450b thereof, and orthogonal to the outer edge 450c thereof, and thus, the reflective polarizer 450 can be cut to the outer edges 80b, 80c orthogonal to each other of a large sheet 80 as shown in FIG. 6(b), the reflective polarizer can be efficiently obtained, and remaining wasteful portions P of the large sheet 80 with the plurality of reflective polarizers 450 cut there from can be reduced, and the number of the obtained reflective polarizers 450 can be increased. Since the number of the obtained reflective polarizers 450 from one large sheet 80 can be increased, the cost per unit reflective polarizer can be reduced, and finally, the manufacturing cost of the liquid crystal display 10 can be reduced.

Even in the case in which the transmission axis direction of the reflective polarizer of the above configuration is rotated by 90° with respect to that of the example in the figure, the cutting-out posture from the large sheet may only be rotated by 90°, and thus, similar effect can be enjoyed.

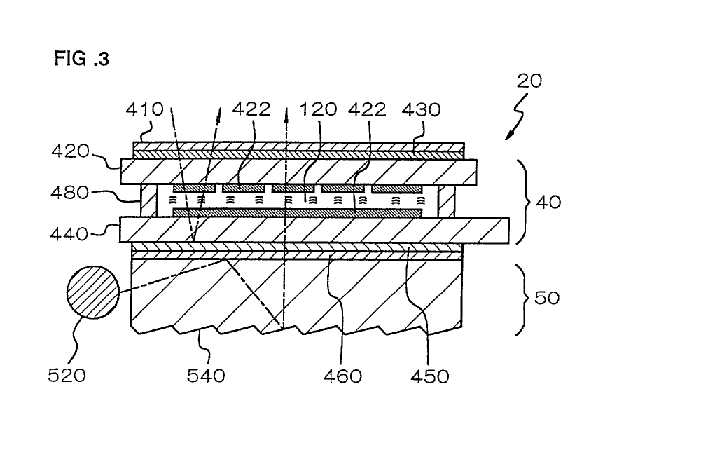

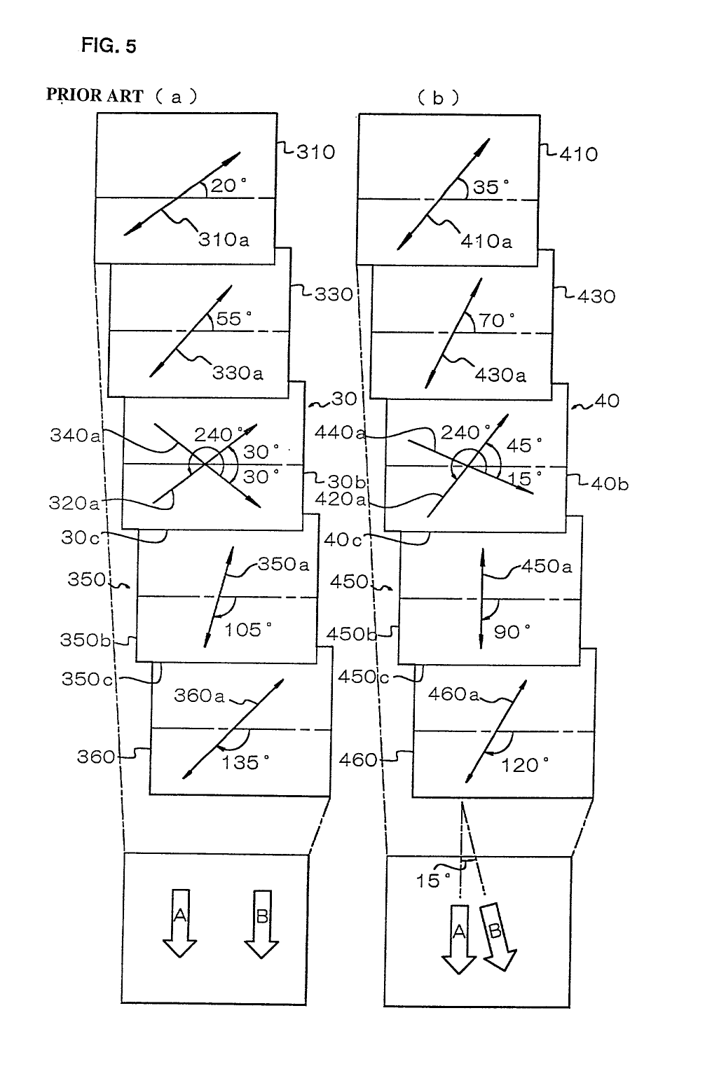

The second embodiment of the present invention will be described with reference to FIGS. 3 and 5(b). FIG. 3 is a schematic longitudinal cross-sectional view of the liquid crystal display according to the second embodiment. FIG. 5(b) is a schematic plan view of individual components of the liquid crystal display according to the second embodiment when viewed from the display surface. In this embodiment, the components of the liquid crystal display according to the second embodiment which are identical to or correspond to those in the first embodiment are represented by the same reference numerals, and a detailed description thereof is omitted.

The liquid crystal display 20 comprises the polarizer 410, the retardation film 430, the liquid crystal panel 40, the reflective polarizer 450 and the backlight 50 of the same structure as those in the first embodiment, and is entirely constituted similar to that according to the first embodiment including the characteristic direction thereof.

In the present embodiment, in addition to the above structure, a polarizer 460 having a predetermined absorption axis direction 460a is disposed between the reflective polarizer 450 and the backlight 50. The absorption axis direction 460a of the polarizer 460 is set in the direction rotated clockwise by 120° with respect to the reference direction when viewed from the front side under the condition in which the characteristic direction of the other member is completely the same as that of the configuration example of the first embodiment.

In this second embodiment, the polarizer 460 is disposed behind the reflective polarizer 450 as shown in FIG. 5(b), and the absorption axis direction 460a of the polarizer 460 is neither parallel to nor orthogonal to the transmission axis direction 450a of the reflective polarizer 450. Therefore, a part of the transmitted light of the reflective polarizer 450 is absorbed by the polarizer 460, the mixing quantity to the display of the scattering light and the reflecting light attributable to the light transmitted through the reflective polarizer 450 can be reduced, the display of higher contrast can be obtained, a part of the light emitted from the backlight 50 can be transmitted through both the polarizer 460 and the reflective polarizer 450, and thus, a transmissive liquid crystal display which can realize both the reflective display and the transmissive display can be constituted thereby.

Next, the configuration example of a liquid crystal display having a liquid crystal panel and a reflective polarizer having the projected form different from those of the first and second embodiments will be described below. This embodiment is different from the first or second embodiment described above, and the liquid crystal display using the reflective polarizer of a rectangular or elliptical shape which is different from the above projected form will be described. The situation of cutting reflective polarizers of a plurality of kinds of projected forms out of the large sheet 80 will be described.

In this embodiment, the configuration of the liquid crystal panel and reflective polarizer except the projected form and the structure of the large sheet 80 are completely the same as those of the above-described first and second embodiments, and the description thereof will be omitted. In this embodiment, only the projected form of the reflective polarizer is a predetermined one, and the projected form of the liquid crystal panel itself may be separate there from. However, the projected form of the reflective polarizer 450, not limited to that of this embodiment, but in every embodiment of the present invention, preferably and substantially matches the liquid crystal display area of the liquid crystal panel.

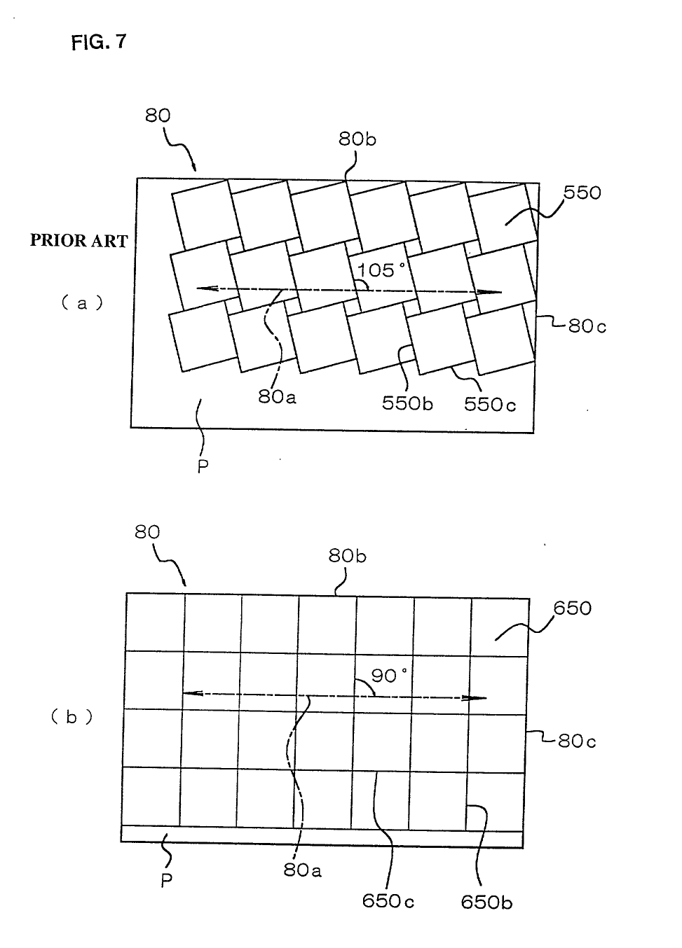

When a reflective polarizer 550 having a square projected form is used in the conventional liquid crystal display comprising components shown in FIGS. 4(a) and 5(a), the reflective polarizer 550 must be cut out so that the transmission axis 80a forms an angle of 105° with respect to a side 550b out of two sides 550b, 550c of the reflective polarizer 550 orthogonal to each other as shown in FIG. 7(a), and wasteful portions which cannot be used as the reflective polarizer 550 are generated in the large sheet 80, and the number of reflective polarizer which can be obtained from the large sheet 80 is reduced thereby.

On the other hand, when a reflective polarizer 650 according to the present embodiment is used, the reflective polarizer can be cut so that the transmission axis 80a is orthogonal to the side 650b out of two sides 650b, 650c of the reflective polarizer 650 orthogonal to each other, and a reflective polarizer 65 can be cut out of the large sheet 80 in a matrix in a similar manner to that of individual embodiments described above, wasteful portions of the large sheet 80 are reduced, and the number of the reflective polarizers which can be obtained from the large sheet 80 can be increased.

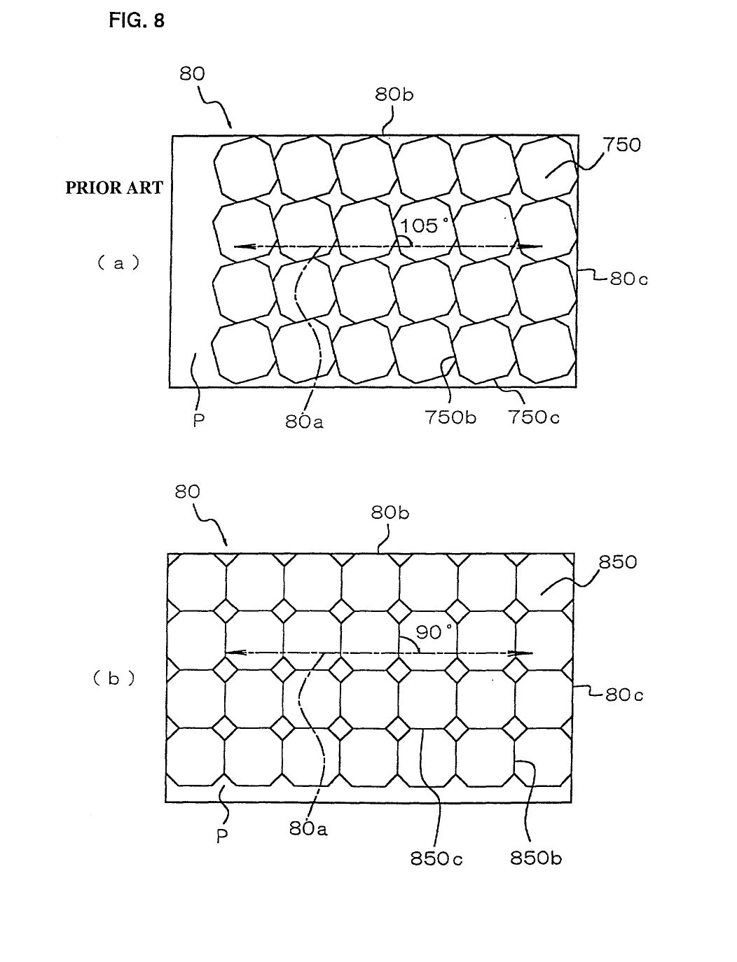

FIG. 8 shows how substantially square reflective polarizers (of square shape with truncated comers or octagonal shape in examples in the figure) are cut out of the large sheet 80. As shown in FIG. 8(a), the projected form of a reflective polarizer 750 used in the conventional liquid crystal display comprises relatively long sides 750b, 750c orthogonal to each other, and short sides formed there between which are alternately arranged in the peripheral direction, and the angle formed by the long side 750b and the transmission axis 80a is 105°. Thus, when the reflective polarizers 750 are cut out of the large sheet 80, wasteful portions are large, and the number of the obtained reflective polarizers is reduced.

On the other hand, as shown in FIG. 8(b), the projected form of a reflective polarizer 850 according to the present embodiment comprises long sides 850b, 850c orthogonal to each other similar to the above and short sides which are alternately arranged in the peripheral direction, and the long side 850b is substantially orthogonal to the transmission axis 80a. Thus, the reflective polarizers can be cut out of the large sheet with the long sides 850b, 850c of the reflective polarizer 850 parallel to or perpendicular to the long sides or short sides of the large sheet 80, and thus, wasteful portions can be reduced in size compared with the case in which the reflective polarizers 750 can be cut out in a manner as shown in FIG. 8(a), and the number of the obtained reflective polarizers can be increased.

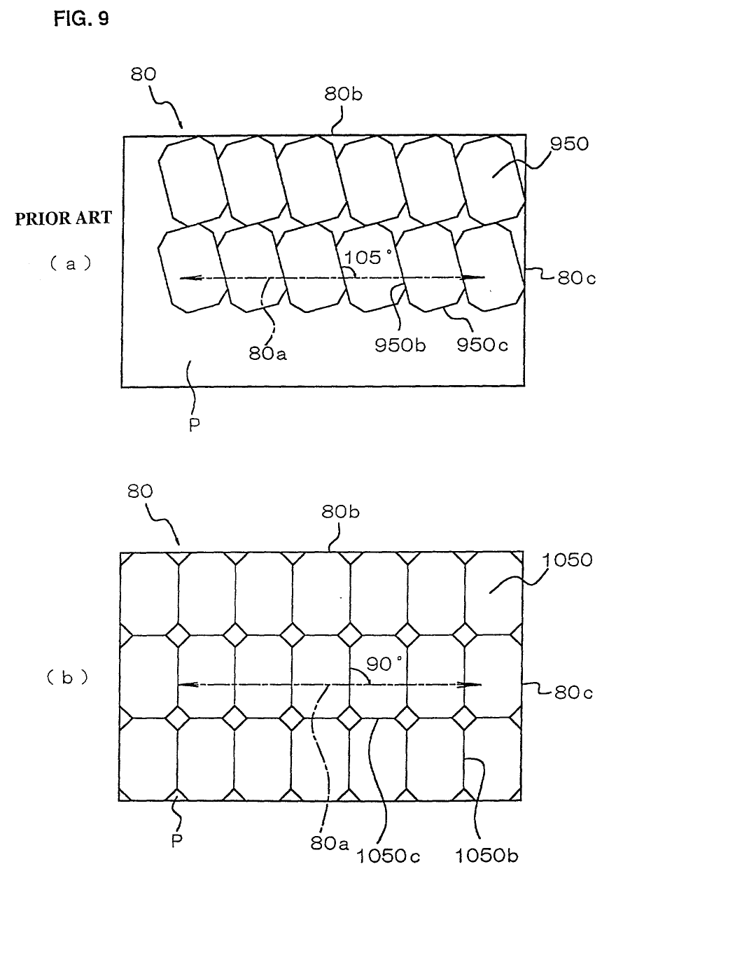

The projected forms of reflective polarizers 950, 1050 shown in FIG. 9 comprise first long sides 950b, 1050b and second long sides 950c, 1050c orthogonal to each other, the first long sides 950b, 1050b are longer than the second long sides 950c, 1050c, and further comprise shorter sides which are shorter than either of the first or second long sides, and either of the first or second long and short sides are alternately arranged in the peripheral direction. Even in the reflective polarizers having such a projected form, the reflective polarizers 1050 shown in FIG. 9(b) can be cut out of the large sheet 80 with less wasteful portions of the large sheet than those of the reflective polarizers 950 shown in FIG. 9(a), and the number of the reflective polarizers can be increased.

The reflective polarizers shown in FIGS. 6 to 9 have substantially polygonal projected forms, and in the reflective polarizers having such a substantially polygonal projected form, at least one side of the projected form is substantially parallel to or substantially orthogonal to the transmission axis or the reflection axis, and the blank layout efficiency of the reflective polarizers can be increased. In particular, in the case of the projected form having sides of different length, the arrangement of the longest side substantially parallel to or substantially orthogonal to the transmission axis or the reflection axis is effective in eliminating wastes.

In the case of the reflective polarizers not of the above-described substantially polygonal projected form but of the projected form having at least one straight side (an outer edge), the blank layout efficiency of the reflective polarizers from a large sheet can be increased by the arrangement that the side (the outer edge) is substantially parallel to or substantially orthogonal to the transmission axis or the reflection axis.

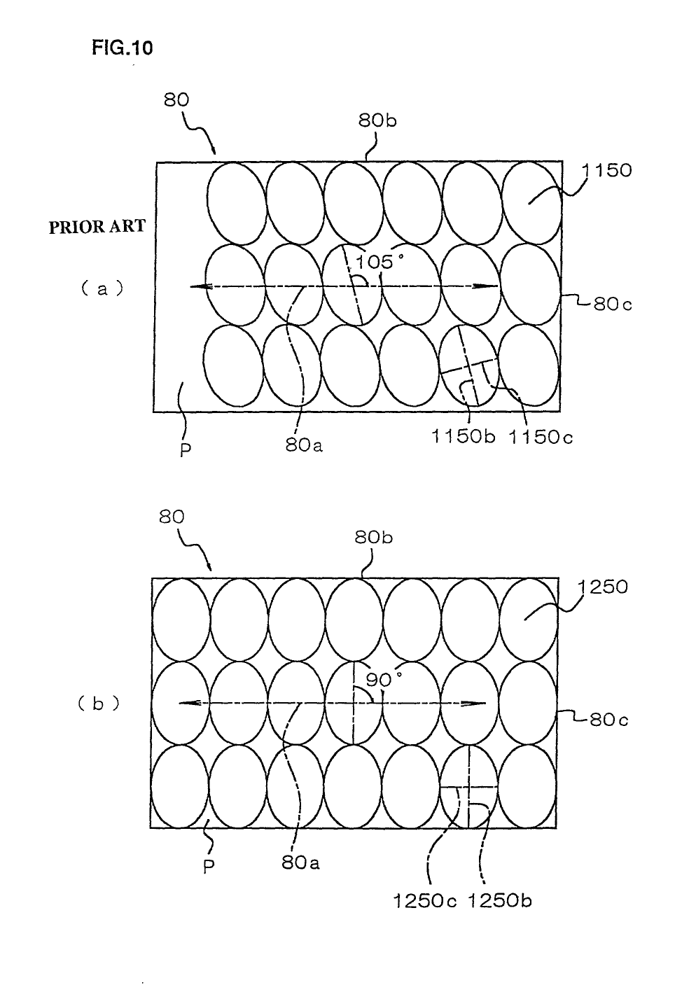

The projected forms of reflective polarizers 1150, 1250 shown in FIG. 10 comprise ellipses having major axes 1150b, 1250b and minor axes 1150c, 1250c. The blank layout efficiency of the reflective polarizers 1250 from the large sheet 80 with the direction of the major axis 1250b, i.e., the longitudinal direction being parallel to or perpendicular to the transmission axis 80a is higher than that of the reflective polarizers 1150 with the direction of the major axis 1150b, i.e., the longitudinal direction not being parallel to or perpendicular to the transmission axis 80a. In the case of this reflective polarizers 1250, the minor axis 1250c is also parallel to or perpendicular to the transmission axis 80a.

The blank layout efficiency from the large sheet can be increased by arranging the longitudinal direction of the projected form to be substantially parallel to or substantially orthogonal to the transmission axis or the reflection axis when using the reflective polarizers not only having the elliptical shape but also having the projected form extended in a predetermined direction.

The liquid crystal display in accordance with the present invention is not limited to the above examples shown in the figures, the embodiments can be arbitrarily modified within the scope of the present invention. For example, in the present invention, the blank layout efficiency of the reflective polarizers is increased by setting the visual angle at 05:30 hours to 06:00 hours by deviating 15°, and the setting of the visual angle is not limited thereto, and the visual angle can be deviated in a range of ±30° in order to increase the blank layout efficiency of the reflective polarizers in a liquid crystal panel with the visual angle set at 03:00, 09:00 or 12:00 hours (in which the direction of the distinct vision is set to parallel to or perpendicular to one side or the longitudinal direction of the panel).

As described above, in accordance with the present invention, the efficiency of cutting out reflective polarizers from a large sheet can be improved, and the manufacturing cost of the liquid crystal display can be reduced accordingly.

The entire disclosure of Japanese Patent Application No. 2000-349638 filed Nov. 16, 2000 and Japanese Patent Application No. 2001-278774 filed Sep. 13, 2001 is incorporated by reference herein.

What is claimed is:

1. A liquid crystal display manufacturing method comprising:
a step of manufacturing a liquid crystal display including a liquid crystal panel with a liquid crystal layer disposed between two substrates, and a reflective polarizer disposed along the liquid crystal panel and having a projected form corresponding to a projected form of the liquid crystal panel,
wherein a polarized component having an oscillating plane in a transmission axis direction is transmitted through said reflective polarizer and a polarized component having an oscillating plane in a reflection axis direction is reflected thereby, and
wherein said liquid crystal panel is constituted with a direction of distinct vision of said liquid crystal panel deviated from a direction substantially parallel to or substantially perpendicular to one side of the projected form of said liquid crystal panel by a predetermined angle so that said transmission axis direction or said reflection axis direction is substantially parallel to or substantially orthogonal to one side of the projected form of said reflective polarizer.

2. A liquid crystal display manufacturing method according to claim 1, wherein said liquid crystal panel is constituted so that an angle formed between one side of the projected form of said liquid crystal panel or the direction orthogonal thereto and said direction of distinct vision is not greater than 30°.

3. A liquid crystal display manufacturing method comprising:
a step of manufacturing a liquid crystal display including a liquid crystal panel with a liquid crystal layer disposed between two substrates, and a reflective polarizer disposed along said liquid crystal panel and having a projected form corresponding to a projected form of said liquid crystal panel,
wherein a polarized component having an oscillating plane in a transmission axis direction is transmitted through said reflective polarizer and a polarized component having an oscillating plane in a reflection axis direction is reflected thereby, and
wherein said liquid crystal panel is constituted with a direction of distinct vision of said liquid crystal panel deviated from a direction substantially parallel to or substantially perpendicular to a longitudinal direction of the projected form of the liquid crystal panel by a predetermined angle so that said transmission axis direction or said reflection axis direction is substantially parallel to or substantially orthogonal to the longitudinal direction of the projected form of said reflective polarizer.

4. A liquid crystal display manufacturing method according to claim 3, wherein said liquid crystal panel is constituted so that an angle formed between the longitudinal direction of the projected form of said liquid crystal panel or the direction orthogonal thereto and said direction of distinct vision is not greater than 30°.

5. A liquid crystal display manufacturing method comprising:
a step of manufacturing a liquid crystal display having a liquid crystal panel with a liquid crystal layer disposed between two substrates, and a reflective polarizer disposed along said liquid crystal panel and having a projected form corresponding to a projected form of said liquid crystal panel,
wherein a polarized component having an oscillating plane in a transmission axis direction is transmitted through said reflective polarizer and a polarized component having an oscillating plane in a reflection axis direction is reflected thereby, and
wherein an alignment treatment for determining an initial alignment direction of liquid crystal molecules in the liquid crystal layer is achieved by deviating said initial alignment direction by a predetermined angle so that said transmission axis direction or said reflection axis direction is substantially parallel to or substantially orthogonal to one side or a longitudinal direction of the projected form of said reflective polarizer.

6. A liquid crystal display manufacturing method according to claim 5, wherein said liquid crystal panel is constituted so that said predetermined angle is not greater than 30°.

7. A liquid crystal display manufacturing method according to claim 1, wherein said reflective polarizer includes said transmission axis direction substantially orthogonal to said reflection axis direction.

8. A liquid crystal display manufacturing method comprising:
a step of manufacturing a liquid crystal display including a liquid crystal panel, a polarizer and a polarization separator, the polarizer and the polarization separator being disposed on both sides of said liquid crystal panel,
wherein said polarization separator has a projected form corresponding to a projected form of said liquid crystal panel and allows light to be transmitted there through or reflected thereby according to a linear polarized component thereof, and
wherein said liquid crystal panel is constituted with a direction of distinct vision of said liquid crystal panel deviated from a direction substantially parallel to or substantially perpendicular to one side of the projected form of said liquid crystal panel by a predetermined angle so that a polarization direction of the linear polarized component transmitted through or reflected by said polarization separator is substantially parallel to or substantially orthogonal to one side of the projected form of said polarization separator.

9. A liquid crystal display manufacturing method according to claim 8, wherein said liquid crystal panel is constituted so that an angle formed between one side of the projected form of said liquid crystal panel or the direction orthogonal thereto and said direction of distinct vision is not greater than 30°.

10. A liquid crystal display manufacturing method comprising:
a step of manufacturing a liquid crystal display including a liquid crystal panel, a polarizer and a polarization separator, the polarizer and polarization separator being disposed on both sides of said liquid crystal panel,
wherein said polarization separator has a projected form corresponding to a projected form of the liquid crystal panel and allows light to be transmitted there through or reflected thereby according to a linear polarized component thereof, and
wherein said liquid crystal panel is constituted with a direction of distinct vision of said liquid crystal panel deviated from a direction substantially parallel to or substantially perpendicular to one side of the projected form of the liquid crystal panel by a predetermined angle so that a polarization direction of said linear polarized component transmitted through or reflected by said polarization separator is substantially parallel to or substantially orthogonal to a longitudinal direction of the projected form of said polarization separator.

11. A liquid crystal display manufacturing method according to claim 10, wherein said liquid crystal panel is constituted so that an angle formed between a longitudinal direction of the projected form of said liquid crystal panel or the direction orthogonal thereto and said direction of distinct vision is not greater than 30°.

12. A liquid crystal display manufacturing method comprising:
a step of manufacturing a liquid crystal display including a liquid crystal panel, a polarizer and a polarization separator, the polarizer and polarization separator being disposed on both sides of said liquid crystal panel,
wherein said polarization separator has a projected form corresponding to a projected form of said liquid crystal panel and allows light to be transmitted there through or reflected thereby according to a linear polarized component thereof, and
wherein an alignment treatment of determining an initial alignment direction of liquid crystal molecules in said liquid crystal layer is achieved by deviating said initial alignment direction by a predetermined angle so that a polarization direction of said linear polarized component transmitted through or reflected by said polarization separator is substantially parallel to or substantially orthogonal to one side or a longitudinal direction of the projected form of said polarization separator.

13. A liquid crystal display manufacturing method according to claim 12, wherein said liquid crystal panel is constituted so that said predetermined angle is not greater than 30°.

14. A liquid crystal display manufacturing method according to claim 8, wherein said polarization separator in which a transmission axis direction indicating a polarization axis direction with maximum transmissivity of said linear polarized component is substantially orthogonal to a reflection axis direction with maximum reflectance of said linear polarized component is used.

15. A liquid crystal display comprising:
a liquid crystal panel having a pair of substrates and a reflective polarizer disposed along one of said substrates,
wherein said reflective polarizer is adapted to allow a polarized component having an oscillating plane in a transmission axis direction to be transmitted there through and a polarized component having the oscillating plane in a reflection axis direction to be reflected thereby, and
wherein said reflective polarizer is constituted so that said transmission axis direction or said reflection axis direction is substantially parallel to or substantially orthogonal to one side of a projected form thereof.

16. A liquid crystal display comprising:
a liquid crystal panel having a pair of substrates and a reflective polarizer disposed along one of said substrates,
wherein said reflective polarizer is adapted to allow a polarized component having an oscillating plane in a transmission axis direction to be transmitted there through and a polarized component having the oscillating plane in a reflection axis direction to be reflected thereby, and
wherein said reflective polarizer is constituted so that said transmission axis direction or said reflection axis direction is substantially parallel to or substantially orthogonal to a longitudinal direction of a projected form thereof.

17. A liquid crystal display comprising:
a liquid crystal panel having a liquid crystal layer between two substrates and a reflective polarizer disposed on the side opposite to a display surface of said liquid crystal panel,
wherein said reflective polarizer is adapted to allow a polarized component having an oscillating plane in a transmission axis direction to be transmitted there through and a polarized component having the oscillating plane in a reflection axis direction to be reflected thereby, and
wherein said reflective polarizer is constituted so that the transmission axis direction or the reflection axis direction is substantially parallel to or substantially orthogonal to one side of a projected form thereof.

18. A liquid crystal display comprising:
a liquid crystal panel having a liquid crystal layer between two substrates and a reflective polarizer disposed on a side opposite to a display surface of said liquid crystal panel,
wherein said reflective polarizer is adapted to allow a polarized component having an oscillating plane in a transmission axis direction to be transmitted there through and a polarized component having the oscillating plane in a reflection axis direction to be reflected thereby, and
wherein said reflective polarizer is constituted so that said transmission axis direction or said reflection axis direction is substantially parallel to or substantially orthogonal to a longitudinal direction of a projected form thereof.

19. A liquid crystal display comprising:
a liquid crystal panel having a liquid crystal layer between two substrates and a liquid crystal display area of a predetermined projected form and a reflective polarizer disposed adjacent said liquid crystal panel and having the projected form substantially similar to said liquid crystal display area,
wherein said reflective polarizer is adapted to allow a polarized component having an oscillating plane in a transmission axis direction to be transmitted there through and a polarized component having the oscillating plane in a reflection axis direction to be reflected thereby, and
wherein said reflective polarizer is disposed in a posture so that said transmission axis direction or said reflection axis direction is substantially parallel to one side of said projected form of said liquid crystal display area.

20. A liquid crystal display comprising:
a liquid crystal panel having a liquid crystal layer between two substrates and a liquid crystal display area of a predetermined projected form and a reflective polarizer disposed adjacent said liquid crystal panel and having the projected form substantially similar to said liquid crystal display area,
wherein said reflective polarizer is adapted to allow a polarized component having an oscillating plane in a transmission axis direction to be transmitted there through and a polarized component having the oscillating plane in a reflection axis direction to be reflected thereby, and
wherein said reflective polarizer is disposed so that said transmission axis direction or said reflection axis direction is substantially parallel to a longitudinal direction of said projected form of said liquid crystal display area.

21. A liquid crystal display according to claim 15, wherein a first polarizer is disposed on a first side of said liquid crystal panel, polarized light transmitted through said first polarizer being controlled according to a voltage applied to said liquid crystal layer whether or not the polarized light is reflected by said reflective polarizer after being transmitted through said liquid crystal panel, and emitted from said first polarizer after being transmitted through said liquid crystal panel.

22. A liquid crystal display according to claim 21, wherein a light source is disposed on opposite side of said reflective polarizer as said liquid crystal panel.

23. A liquid crystal display according to claim 15, wherein the liquid crystal display is a transflective liquid crystal display having a reflective display function which implements display by reflecting external light and a transmissive display function which implements display by transmitting light emitted from a light source.

24. A liquid crystal display according to claim 15, wherein said liquid crystal panel has a liquid crystal layer in an STN mode.

25. A liquid crystal display according to claim 15, wherein a second polarizer which absorbs light transmitted through said reflective polarizer is disposed on an opposite side of said reflective polarizer as said liquid crystal panel.

26. A liquid crystal display according to claim 15, wherein a second polarizer is disposed on an opposite side of said reflective polarizer as said liquid crystal panel so that a transmission axis of said reflective polarizer is diagonal to an absorption axis of said second polarizer.

27. A liquid crystal display comprising:
a liquid crystal panel, a polarizer and a polarization separator, the polarizer and polarization separator being disposed on both sides of said liquid crystal panel,
wherein said polarization separator has a projected form corresponding to a projected form of said liquid crystal panel, and is adapted to allow the light to be transmitted there through and reflected thereby according to a linear polarized component, and
wherein a polarization direction of said linear polarized component transmitted through or reflected by said polarization separator is substantially parallel to or substantially orthogonal to one side of the projected form of said polarization separator.

28. A liquid crystal display according to claim 27, wherein an angle formed between one side of the projected form of said liquid crystal panel or a direction orthogonal thereto and a direction of distinct vision of said liquid crystal panel is not greater than 30°.

29. A liquid crystal display comprising:
a liquid crystal panel, a polarizer and a polarization separator, the polarizer and polarization separator being disposed on both sides of said liquid crystal panel,
wherein said polarization separator has a projected form corresponding to a projected form of said liquid crystal panel, and is adapted to allow light to be transmitted there through and reflected thereby according to a linear polarized component, and
wherein a polarization direction of said linear polarized component transmitted through or reflected by said polarization separator is substantially parallel to or substantially orthogonal to a longitudinal direction of the projected form of said polarization separator.

30. A liquid crystal display according to claim 29, wherein an angle formed between a longitudinal direction of the projected form of said liquid crystal panel or the direction orthogonal thereto and a direction of distinct vision of said liquid crystal panel is not greater than 30°.

31. A liquid crystal display according to claim 27, wherein said polarization separator is constituted so that a transmission axis direction indicating a polarization axis direction with maximum transmissivity of said linear polarized component is substantially orthogonal to a reflection axis direction indicating a polarization axis direction with the maximum reflectance of said linear polarized component.

32. A liquid crystal display according to claim 27, wherein a second polarizer which absorbs light transmitted through said polarization separator is disposed on an opposite side of said polarization separator as said liquid crystal panel.

33. A liquid crystal display according to claim 27, wherein a second polarizer is disposed on an opposite side of said polarization separator as said liquid crystal panel and a transmission axis direction indicating a polarization axis direction with maximum transmissivity of said linear polarized component of said polarization separator is diagonal to a reflection axis direction with maximum absorption of the linear polarized component of said second polarizer.

34. A liquid crystal display according to claim 27, wherein said liquid crystal panel has a liquid crystal layer in an STN mode.
